(19) United States
(12) Patent Application Publication
(10) Pub. No.: US 2026/0141842 A1
(43) Pub. Date: May 21, 2026

(54) FACE MASK THAT FACILITATES SWITCHING DISPLAY IMAGES

(71) Applicant: PUJUN WANG, SHENZHEN (CN)

(72) Inventor: PUJUN WANG, SHENZHEN (CN)

(21) Appl. No.: 18/973,066

(22) Filed: Dec. 8, 2024

(30) Foreign Application Priority Data
Nov. 15, 2024 (CN) 202422794057.5

(51) Int. Cl. G09G 3/32; A41D 31/04; G06F 3/02; G06F 3/16; H04R 1/02

(52) U.S. Cl. CPC G09G 3/32; A41D 31/04; G06F 3/02; G06F 3/167; H04R 1/028; G09G 2354/00; H04R 2499/15

(57) ABSTRACT

Disclosed is a face mask that facilitates switching display images. The face mask includes: a housing, where a mounting groove of a certain depth is formed on a surface of the housing; a lamp panel display screen, where the lamp panel display screen is arranged in the mounting groove, sealed and fixed through glue filling; a control module, a microphone and a storage module are further arranged in the mounting groove, and the control module is electrically connected to the microphone, the storage module and the lamp panel display screen; and the storage module stores various different images, the lamp panel display screen is configured for displaying images stored in the storage module, the microphone is configured for picking up a control signal from a user, and the control module receives the control signal and switches an image on the lamp panel display screen according to the control signal.

### CROSS REFERENCE TO RELATED APPLICATIONS

The present application claims the priority of Chinese patent application No. 202422794057.5, filed on Nov. 15, 2024, and contents of which are incorporated herein by reference.

### TECHNICAL FIELD

The present disclosure relates to the technical field of face masks, and in particular to a face mask that facilitates switching display images.

### BACKGROUND

To enhance an image resolution and delicacy, an electronic face mask with a LED screen in the prior art is provided with thousands of LED lamp beads. The electronic face mask usually employs a row-column scanning method to drive the lamp beads, and specifically the LED lamp beads on the face mask are sorted by rows and columns, where red, green and blue leads of the LED lamp beads in each row are separately connected and separately communicated with an I/O port of a controller. Common ends of the LED lamp beads in each column are connected, the common ends of each column are communicated with the I/O port of the controller, and a display screen of the electronic face mask is formed in this way. Through the I/O port of the controller, a drive signal is outputted to each lamp bead to light up, and different patterns can be presented by controlling a series of illuminated LED lamp beads.

Electronic face masks equipped with LED screens currently available on the market have single functions, and usually display predetermined content only. There are few interactions between users and the electronic face masks. To modify display content of an electronic face mask, a user needs to reconnect a data cable and modify information on the electronic face mask, which results in a poor user experience in practical use.

### SUMMARY

In order to solve the above problems, the present disclosure provides a face mask that facilitates switching display images, and a user can switch a display image on a lamp panel display screen of the face mask, in a very simple and convenient manner.

The present disclosure provides a face mask that facilitates switching display images, including:
a housing, where a mounting groove of a certain depth is formed on a surface of the housing;
a lamp panel display screen, where the lamp panel display screen is arranged in the mounting groove, sealed and fixed through glue filling;
a control module, a microphone and a storage module are further arranged in the mounting groove, and the control module is electrically connected to the microphone, the storage module and the lamp panel display screen; and
the storage module stores various different images, the lamp panel display screen is configured for displaying images stored in the storage module, the microphone is configured for picking up a control signal from a user, and the control module receives the control signal and switches an image on the lamp panel display screen according to the control signal.

In some examples, the lamp panel display screen includes a lamp panel and LED lamp beads, the LED lamp beads are arranged on the lamp panel in a shape of a matrix, the housing and the lamp panel are arc-shaped, and an overall shape of the housing matches a human face.

In some examples, the microphone is arranged to be close to a user's mouth and a bottom of the housing, and the microphone penetrates through the housing.

In some examples, the face mask is further provided with at least one switching button, and the switching button is electrically connected to the control module.

In some examples, the face mask is further provided with a voice module and a loudspeaker, the voice module is electrically connected to the control module, the loudspeaker is electrically connected to the voice module, and the voice module or the storage module stores a plurality of sets of voice name information corresponding to image information stored in the storage module.

In some examples, the face mask is further provided with a switch button, the switch button is connected to a battery, and the switch button is configured for turning on/off the face mask.

In some examples, the face mask is provided with an elastic band, and the elastic band is connected to a connecting part formed by extending outward from both sides of the housing.

In some examples, an observation hole, or a transparent area, or a hollow area is arranged in an area of the housing close to a user's eyes.

In some examples, the face mask is further provided with a nose pad, the nose pad is located in an area close to a user's nose, and the nose pad includes two protruding structures that support the face mask, and is filled with sponge or foam inside.

In some examples, the housing and the lamp panel can be of a planar structure or a structure of any shape.

The above at least one technical solution adopted in the examples of the present disclosure can achieve the following beneficial effects:
1. Due to arrangement of the microphone and the control module, a user can switch a display image on the lamp panel by blowing air, in a very simple and convenient manner.
2. Through arrangement of the mounting groove on the housing, the lamp panel is installed in the mounting groove, sealed and fixed through glue filling, which improves a waterproof effect of the face mask and enriches usage scenarios, with a simple structure.
3. The present disclosure includes the voice module and the loudspeaker, the voice module stores voice information corresponding to graphics, when the lamp panel switches a display image, and the voice module synchronously plays corresponding voice information to prompt a user, which facilitates quick and accurate selection of a desired display image in a very convenient manner.
4. In the present disclosure, a user can select an automatic mode and a manual mode through a button, and have access to more convenient image switching solutions.

### BRIEF DESCRIPTION OF THE DRAWINGS

The accompanying drawings described herein are used for providing further understanding of present disclosure, and constitute part of the present disclosure. Illustrative examples and their descriptions of the present disclosure are intended to explain the present disclosure, but not constitute an undue limitation on the present disclosure. In the figures:

FIG. 1 illustrates a front view of a face mask of the present disclosure.

FIG. 2 illustrates a rear view of a face mask of the present disclosure.

FIG. 3 illustrates a pattern state change diagram (I) of a lamp panel display screen of the present disclosure.

FIG. 4 illustrates a pattern state change diagram (II) of a lamp panel display screen of the present disclosure.

FIG. 5 illustrates a circuit block diagram of a face mask according to Example 1 of the present disclosure.

FIG. 6 illustrates a circuit block diagram of a face mask according to Example 2 of the present disclosure.

FIG. 7 illustrates a circuit block diagram of a face mask according to Example 3 of the present disclosure.

FIG. 8 illustrates a front view of a face mask with a nose pad structure of the present disclosure.

Reference numerals in the accompanying drawings:
housing 10, microphone 11, switch button 12, loudspeaker 13, observation hole 14, elastic band 15, nose pad 16, and lamp panel display screen 20.

### DETAILED DESCRIPTIONS OF THE EMBODIMENTS

In order to make the objectives, technical solutions and advantages of the present disclosure clearer, the technical solutions of the present disclosure will be clearly and completely described with reference to specific examples and corresponding accompanying drawings of the present disclosure. Apparently, the examples described are merely some rather than all of the examples of the present disclosure. Based on the examples of the present disclosure, all other examples acquired by those of ordinary skill in the art without making creative efforts fall within the scope of protection of the present disclosure.

The technical solutions provided in various examples of the present disclosure will be described in detail below with reference to the accompanying drawings.

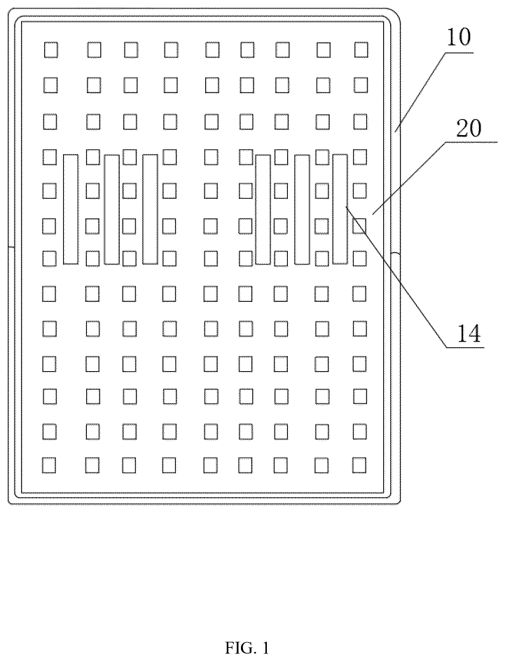

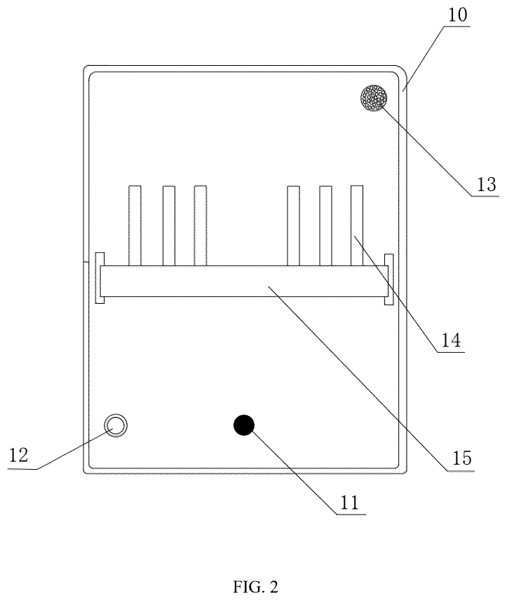

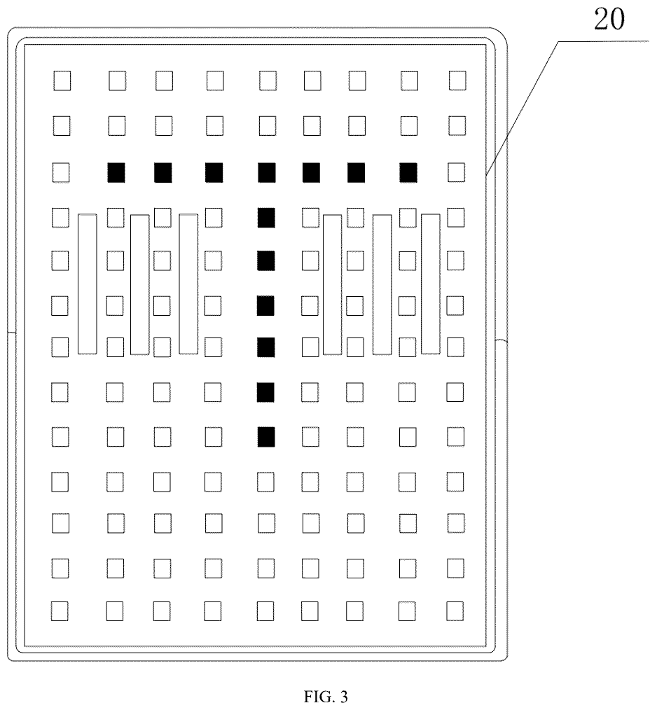

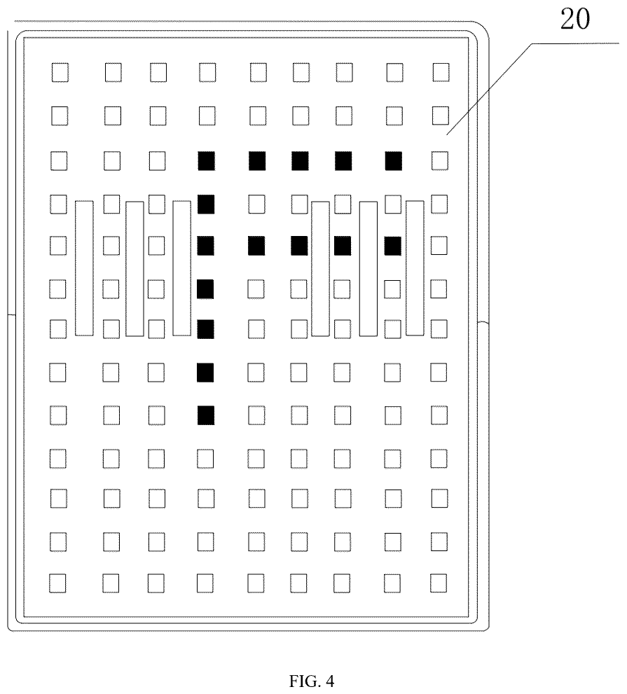

The present disclosure provides a face mask that facilitates switching display images. As illustrated in FIGS. 1-8, the face mask includes a housing 10, a lamp panel display screen 20, a microphone 11, a storage module, and a control module, where a mounting groove of a certain depth is formed on a surface of the housing 10, and the control module, the microphone 11 and the storage module are arranged in the mounting groove, sealed and fixed on the housing 10 through glue filling, which helps to improve an overall waterproof effect and enrich usage scenarios of the face mask. The lamp panel display screen 20, the microphone 11, the storage module, and the control module are electrically connected.

In an example of the present disclosure, the lamp panel display screen 20 includes a lamp panel and LED lamp beads, a plurality of the LED lamp beads are arranged on the lamp panel in a shape of a matrix, the storage module is configured for storing various different images, the lamp panel display screen 20 is configured for displaying images stored in the storage module, the microphone 11 is configured for picking up a control signal from a user, and the control module is configured for receiving the user's control signal and switching the display image on the lamp panel accordingly according to the control signal. In the present disclosure, the microphone 11 is a capacitive microphone, airflow generated during exhalation causes deformation of a conductive film, induces changes in equivalent capacitance and generates a control signal. The control module identifies the control signal and switches the display image on the lamp panel accordingly according to the control signal.

In an example of the present disclosure, the control module is arranged in the mounting groove on the housing 10, is in signal connection to the lamp panel display screen 20, and is configured for controlling on/off states of the LED lamp beads arranged in the shape of a matrix, playback and switching of patterns on the lamp panel display screen 20, and the like. In a specific example, the control module can be a microcontroller unit (MCU), which has a plurality of input and output points and is capable of achieving stable multi-channel control functions.

In an example of the present disclosure, the storage module is arranged in the mounting groove on the housing 10, is in signal connection to the control module, and is configured for pre-storing information data to be played, such as patterns, text, videos and the like. A random access memory (RAM) or a read-only memory (ROM) can be selected as the storage module to achieve data storage functions.

In an example of the present disclosure, as illustrated in FIGS. 1-4, a plurality of the LED lamp beads are arranged on the lamp panel, each of the LED lamp beads of the lamp panel display screen 20 can be controlled to light up, turn off and change colors separately in a regular manner, and different patterns and expressions can be formed on a surface of the face mask through cooperation of the plurality of the LED lamp beads. Compared to face masks in the prior art, the present disclosure increases fun.

In an example of the present disclosure, a user can pre-store patterns and other information in the storage module according to his/her needs. While wearing the face mask, the user can control the lamp panel display screen 20 to display desired pattern information through a voice control module.

In an example of the present disclosure, the housing 10 and the lamp panel are arc-shaped, an overall shape of the housing 10 matches a human face, such that it can be fitted on the human face, and the housing 10 can be made of rigid plastic. The lamp panel is fitted with the housing 10, the arc-shaped housing 10 can cover a larger area of the human face, and when the housing 10 is in an inward rolling shape, changes in the content displayed on the lamp panel can be observed at a wider angle.

In an example of the present disclosure, the housing 10 and the lamp panel can be of a planar structure or a structure of any shape, to provide more options for users with different needs.

In an example of the present disclosure, the face mask further contains a battery, the battery is arranged in the mounting groove on the housing 10, and the battery is electrically connected to the lamp panel display screen 20, the microphone 11, the storage module and the control module, and configured for supplying power to the lamp panel display screen 20, the microphone 11, the storage module and the control module.

In an example of the present disclosure, the face mask is further provided with a wireless communication module, the wireless communication module is in signal connection with the control module, and the wireless communication module includes one or more of a GSM module, a 4G module, a 5G module, a WiFi module, or a Bluetooth module. The wireless communication module is primarily configured for communication of a smart face mask with an external device such as a user's smartphone, and the user can transmit desired display patterns to the storage module of the smart face mask through the external device.

In an example of the present disclosure, the face mask is further provided with a switch button 12, the switch button 12 is connected to the battery, and the switch button 12 is configured for turning on/off the face mask.

In an example of the present disclosure, the face mask is provided with an elastic band 15, a connecting part is formed by extending outward from both sides of the housing 10, a connecting hole is formed in the connecting part, and both ends of the elastic band 15 are fixed in the connecting hole. The elastic band 15 is a long band made of an elastic material such as rubber, both ends of the elastic band 15 are threaded into two connecting holes on both sides of the housing 10 and fixed with screws and the like. In this way, the face mask, through the elastic band 15, can be fixed to the face of a user, and tightness of the elastic band 15 can be adjusted by rotating the screws, thereby applying to different groups of users.

In an example of the present disclosure, an observation hole 14, or a transparent area, or a hollow area is arranged in an area corresponding to a user's eyes to facilitate the user's observation.

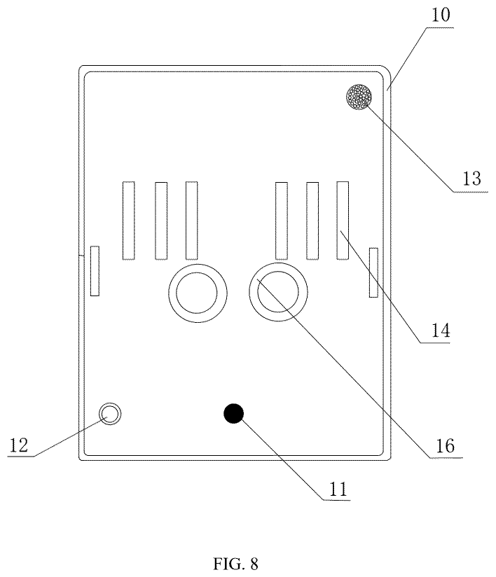

In an example of the present disclosure, as illustrated in FIG. 8, the face mask is further provided with a nose pad, the nose pad is located in an area close to a user's nose, and the nose pad includes two protruding circular or annular structures that are arranged opposite to each other and support the face mask, and is filled with sponge or foam inside.

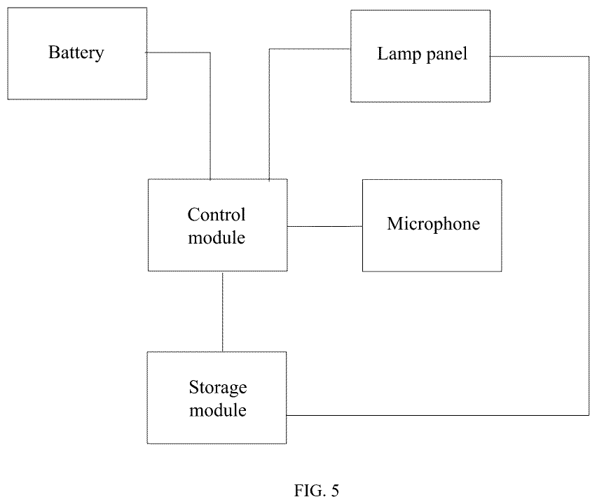

In Example 1 of the present disclosure, as illustrated in FIG. 5, the microphone 11 inside the face mask is electrically connected to the control module. The microphone 11 is configured for picking up a control signal from a user, the control signal is an airflow signal generated when the user blows at a certain frequency, and the microphone 11 transmits the received airflow signal to the control module. The microphone 11 is arranged to be close to a user's mouth and a bottom of the housing 10, and the microphone 11 penetrates through the corresponding housing 10. The user can switch a display image on the lamp panel display screen 20 of the face mask by blowing air, in a very simple and convenient manner.

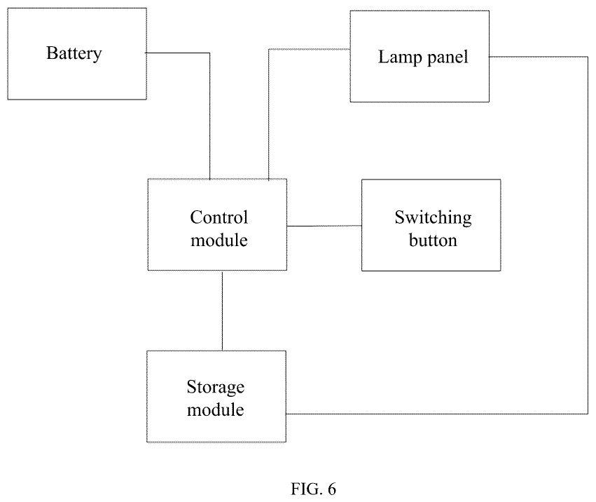

In Example 2 of the present disclosure, as illustrated in FIG. 6, the face mask is further provided with at least one switching button, and the switching button is connected to the control module. When a user long-presses or double-clicks the switching button, the face mask can enter an automatic looping mode. When the switching button is pressed, the control module controls the lamp panel display screen 20 to switch to a new display pattern or graphic after 20N seconds in the automatic looping mode. Alternatively, this can be achieved through manual operations such as single-clicking the switching button, that is, once the switching button is pressed, the lamp panel display screen 20 switches to a next pattern or graphic in a loop.

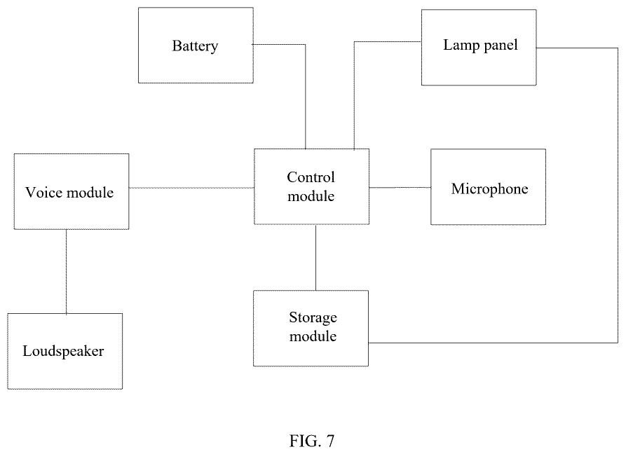

In Example 3 of the present disclosure, as illustrated in FIG. 7, the face mask is further provided with a voice module and a loudspeaker 13, the voice module is connected to the control module, and the loudspeaker 13 is connected to the voice module. The voice module or the storage module stores a plurality of sets of voice name information corresponding to image information stored in the storage module. When the control module switches a display image, the control module controls the voice module and the loudspeaker 13 to play a corresponding voice prompt (i.e., playing a voice of “T” for a letter“T”, playing a voice of “F” for a letter“F”, playing a voice of “tiger” for an image “tiger”, playing a sound of “heart” for a heart-shape image, and the like), which prompts a user to quickly switch to a desired display image in a very convenient manner.

In the present disclosure, the voice module contains corresponding voice names for patterns or graphics, and when the lamp panel display screen 20 switches to a corresponding pattern or graphic, the voice module, through the loudspeaker 13, broadcasts a name of the pattern or graphic, such that a user of the face mask can quickly and accurately select and switch a desired pattern or graphic.

In the description of the present disclosure, it should be understood that orientation or position relationships indicted by terms such as “front”, “rear”, “upper”, “lower”, “left”, “right”, “lateral”, “vertical”, “horizontal”, “top”, “bottom”, and the like are based on orientation or position relationships shown in the drawings, and are merely to facilitate the description of the present disclosure and simplify the description. In the absence of any specific description to the contrary, these position terms do not indicate or imply that the indicated device or element must have particular orientations or be constructed and operated in particular orientations, and cannot be construed as limiting the present disclosure.

For those skilled in the art, various corresponding changes and modifications can be made based on the technical solutions and concepts described above, and all such changes and modifications should fall within the protection scope indicated in the claims of the present disclosure.

1. A face mask that facilitates switching display images, comprising:
a housing, wherein a mounting groove is formed on a surface of the housing;
a lamp panel display screen, wherein the lamp panel display screen is arranged in the mounting groove, sealed and fixed through glue filling;
a control module, a microphone and a storage module are further arranged in the mounting groove, and the control module is electrically connected to the microphone, the storage module, and the lamp panel display screen; wherein the control module is a microcontroller unit; and
the storage module stores various different images, the lamp panel display screen is configured for displaying images stored in the storage module, the microphone is configured for picking up a control signal from a user, and the control module receives the control signal and switches an image on the lamp panel display screen according to the control signal;
wherein the microphone is a capacitive microphone, airflow generated during exhalation causes deformation of a conductive film, induces changes in equivalent capacitance and generates the control signal;
wherein the control signal is an airflow signal generated when the user blows at a frequency, and the microphone transmits a received airflow signal to the control module;
wherein an observation hole or a hollow area is arranged in an area of the housing close to a user's eyes;
wherein the face mask is further provided with a loudspeaker, the storage module stores a plurality of sets of voice name information corresponding to image information stored in the storage module.

2. The face mask according to claim 1, wherein the lamp panel display screen comprises a lamp panel and LED lamp beads, the LED lamp beads are arranged on the lamp panel in a shape of a matrix, the housing and the lamp panel are arc-shaped, and an overall shape of the housing matches a human face.

3. The face mask according to claim 1, wherein the microphone is arranged to be close to a user's mouth and a bottom of the housing, and the microphone penetrates through the housing.

4. The face mask according to claim 1, wherein the face mask is further provided with at least one switching button, and the switching button is electrically connected to the control module.

5. (canceled)

6. The face mask according to claim 1, wherein the face mask is further provided with a switch button, the switch button is electrically connected to a battery, and the switch button is configured for turning on/off the face mask.

7. The face mask according to claim 1, wherein the face mask is provided with an elastic band, and the elastic band is connected to a connecting part formed by extending outward from both sides of the housing.

8. (canceled)

9. The face mask according to claim 1, wherein the face mask is further provided with a nose pad, the nose pad is located in an area close to a user's nose, and the nose pad includes two protruding structures that support the face mask, and is filled with sponge or foam inside.

10. The face mask according to claim 1, wherein the housing and the lamp panel are configured to be of a planar structure or a structure of any shape.
